(19) United States
(12) Patent Application Publication
(10) Pub. No.: US 2010/0109214 A1
(43) Pub. Date: May 6, 2010

(54) Assembly For Transporting Pressurized Fluid and Method of Manufacture

(75) Inventor: Jeffrey M. Polidan, Fenton, MI (US)

Correspondence Address: Quinn Law Group, PLLC, 39555 Orchard Hill Place, Suite 520, Novi, MI, 48375, US

(73) Assignee: GM GLOBAL TECHNOLOGY OPERATIONS, INC., Detroit, MI (US)

(21) Appl. No.: 12/264,343

(22) Filed: Nov. 4, 2008

(51) Int. Cl. F16L 5/00; F16F 13/14; B29C 69/00

(52) U.S. Cl. 267/140.13; 248/56; 264/241

(57) ABSTRACT

A pressurized fluid transport assembly includes a flexible component, such as a molded rubber component, that defines an interior passage through which the pressurized fluid flows. A sleeve surrounds at least a portion of the outer surface of the flexible component. The flexible component fits through an aperture in a support wall, such as a transmission casing, and has opposing first and second end portions configured to fit flush with a pressure source and a pressure destination when the component is through the aperture. The sleeve prevents expansion of the flexible component due to the pressurized fluid, such as expansion radially outward from the interior passage, but does not compromise the flexibility of the flexible component in a direction substantially parallel with the interior passage. A method of manufacturing the pressurized fluid transport assembly is also provided.

### TECHNICAL FIELD

The invention relates to an assembly for transporting pressurized fluid, such as in a vehicle transmission, and a method of manufacturing such an assembly.

### BACKGROUND OF THE INVENTION

Pressurized fluid transport mechanisms are widely used in vehicle transmissions and engines to direct pressurized fluid as necessary for clutch engagement and other functions. Rigid metal tubes overmolded with rubber are known. The inner metal tube is necessary to provide the rigidity required to prevent blowout of the mechanism under the high fluid pressure forces.

### SUMMARY OF THE INVENTION

An assembly for transporting pressurized fluid is provided that prevents expansion due to fluid pressure and the undesirable associated fluid pressure fluctuations associated with such expansion, while at the same time offering flexibility to compensate for tolerance variances in the components between which the fluid is transported, such as in a vehicle transmission or engine. Additionally, the assembly is easier to manufacture and assemble than known pressurized fluid transport devices.

Specifically, the assembly includes a flexible component, such as a molded rubber or other elastomer, that defines an interior passage through which the pressurized fluid flows. A sleeve surrounds at least a portion of the outer surface of the flexible component. The flexible component fits through an aperture in a support wall, such as a transmission casing, and has opposing first and second end portions configured to fit flush with a pressure source and a pressure destination when the component is through the aperture. The sleeve prevents expansion of the flexible component due to the pressurized fluid, such as expansion radially outward from the interior passage, but does not compromise the flexibility of the flexible component in a direction substantially parallel with the interior passage, thereby allowing compression between the two end portions as necessary to account for tolerance variances in the assembled pressure source and pressure destination. By preventing expansion, bursting of the respective seals formed between the end portions and the pressure source and pressure destination is avoided.

The sleeve may extend substantially from the first end portion to the second end portion through the aperture. Alternatively, first and second sleeves may be used to surround only the portions of the outer surface of the flexible component between the pressure source and the support wall, and between the pressure destination and the support wall, respectively. In another embodiment, the sleeve may be a spring, such as a wound wire that is compressible in the direction of the interior passage.

The flexible component may have multiple interior passages and conduit portions that are connected to one another via a flange molded from the same material and preferable unitary with the conduit portions. The sleeve as well may be a unitary sleeve configured to surround the outer surfaces of multiple conduit portions of a flexible component.

An optimal method of manufacturing a pressurized fluid transfer assembly includes extending a core pin into a die cavity for a die assembly and then molding the flexible component around the core pin in the die cavity without inserting any separate components in the die cavity so that the molded flexible component is of a single molded material and forms an internal passage around the core pin. That is, there is no rigid support molded within the flexible component, so a step of placing such a rigid component is avoided. This is beneficial, because time delay and more difficult temperature control of the die associated with repeated opening and closing of the die to insert such a rigid component is avoided. When the core pin is withdrawn and the molded flexible component is ejected from the die cavity, a sleeve can be placed around the flexible component to serve the purpose of preventing expansion due to fluid pressure, as discussed above.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic side view illustration of a first embodiment of a flexible molded component for transporting fluid;

FIG. 2 is a schematic side view illustration of a sleeve configured for use with the flexible component of FIG. 1 as a pressurized fluid transport assembly;

FIG. 3 is a schematic end view illustration of the sleeve of FIG. 2;

FIG. 4 is a schematic side view illustration of a second embodiment of a flexible molded component for transporting fluid;

FIG. 5A is a schematic side view illustration of a sleeve configured for use with the flexible component of FIG. 4 as a pressurized fluid transport assembly;

FIG. 5B is a schematic side view illustration of another sleeve configured for use with the flexible component of FIG. 4 as an alternative pressurized fluid transport assembly;

FIG. 6 is a schematic side view illustration of the pressurized fluid transport assembly utilizing the flexible molded component of FIG. 1 and sleeves as shown in FIGS. 2 and 3 to transport fluid from a transmission valve body to a clutch cavity within a transmission casing;

FIG. 7 is a schematic cross-sectional illustration of the pressurized fluid transport assembly taken at the lines 7-7 in FIG. 6;

FIG. 8 is a schematic side view illustration of a third embodiment of a pressurized fluid transport assembly;

FIG. 9 is a schematic end view illustration of the pressurized fluid transport assembly of FIG. 8;

FIG. 10 is a schematic side view illustration of a fourth embodiment of a pressurized fluid transport assembly;

FIG. 11 is a schematic end view illustration of the pressurized fluid transport assembly of FIG. 10;

FIG. 12 is a schematic cross-sectional illustration of a die assembly for molding the flexible component of FIG. 4;

FIG. 13 is a flow diagram illustrating a method of manufacturing pressurized fluid transport assemblies.

### DESCRIPTION OF THE PREFERRED EMBODIMENTS

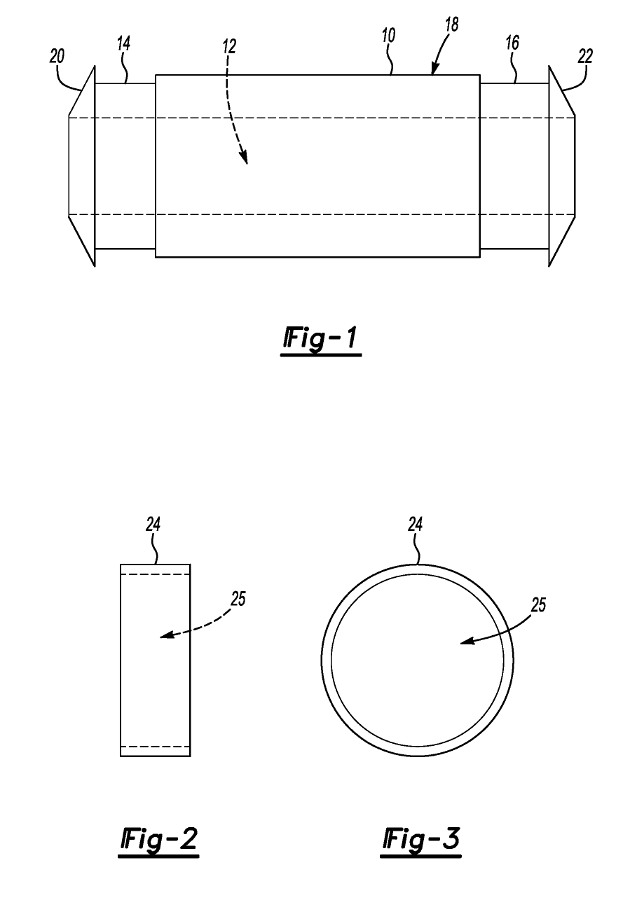

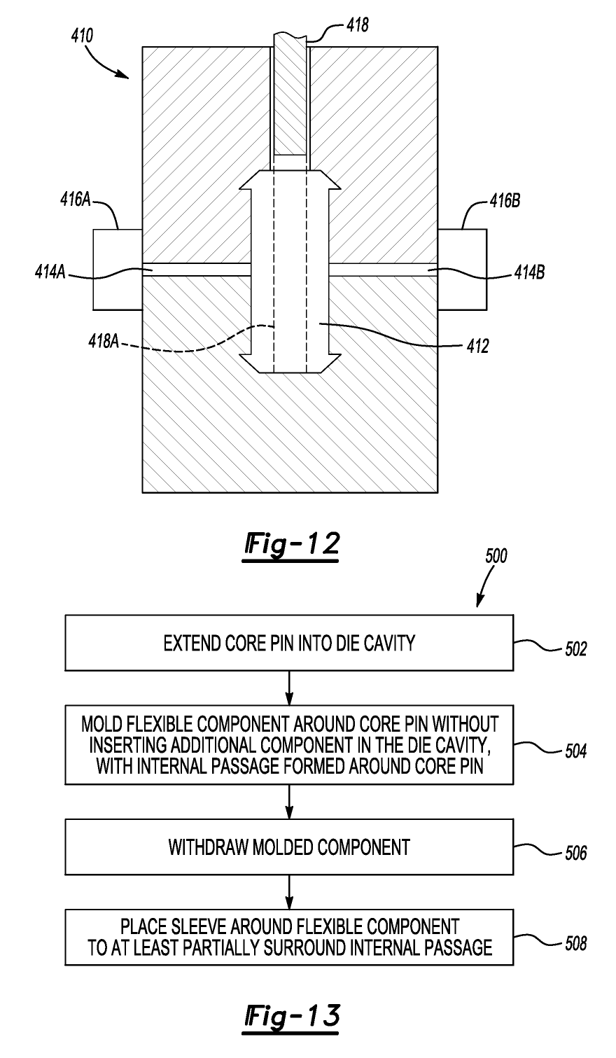

Referring to the drawings, wherein like reference numbers refer to like components, FIG. 1 shows a flexible component 10 formed with an interior passage 12 passing completely through the component 10. The flexible component 10 may be rubber or any other elastomer, and may be blow-molded according to the method of manufacture described herein. The flexible component 10 is a single, unitary component of a single material, such as an elastomer, and is not overmolded onto any support structure, such as prior art fluid transport mechanisms. This simplifies the manufacturing process, as described below with respect to FIGS. 12 and 13.

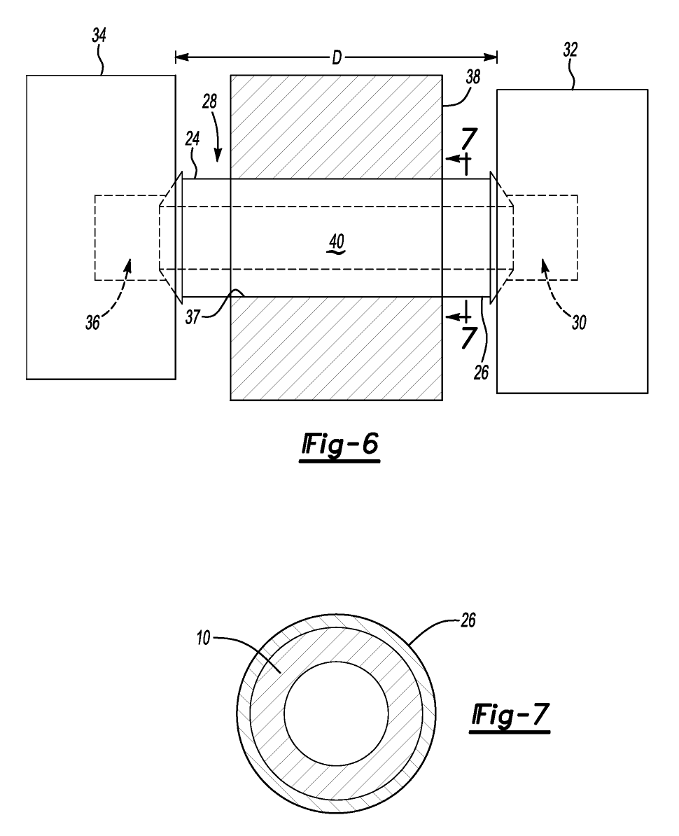

The flexible component 10 is formed with first and second recessed portions 14, 16 along an outer surface 18 thereof. The first and second recessed portions 14, 16 are adjacent respective tapered first and second end portions 20, 22. Referring to FIGS. 2 and 3, a substantially rigid annular first sleeve 24 forms an opening 25 sized to fit snugly around the outer surface 18 in the recessed portion 14 of the flexible component 10, as shown in FIG. 6. A substantially identical second sleeve 26 is sized to fit snugly around the outer surface 18 in the recessed portion 16, also shown in FIG. 6.

The flexible component 10 with sleeves 24, 26 placed thereon forms an assembly 28 configured to transport pressurized fluid from a passage 30 in a pressure source 32, such as a transmission valve body operatively connected with a transmission pump (not shown), to a pressure destination 34, such as a support member within the transmission having a fluid channel 36 operatively connected with a pressure cavity for a transmission clutch (not shown). The assembly 28 is configured to pass through an aperture 37 in a support wall 38, such as an outer wall of a transmission casing. The end portions 20, 22 are flush fit against the pressure destination 34 and the pressure source 32 at the passage 30 and fluid channel 36, respectively. The flexibility of the component 10 allows the component 10 to compress slightly as necessary to maintain adequate sealing at the passage 30 and channel 36 while accommodating for slight build tolerances or variances in the distance D between the pressure source 32 and the pressure destination 34. Because the sleeves 24 and 26 surround only portions of the outer surface 18, they do not interfere with compression of the component 10 in a direction parallel with the interior passage 12 (i.e., an axial direction), especially compression of the end portions 20, 22. The sleeves 24, 26 do not extend into the opening 37, although in other embodiments they may. The sleeves 24, 26 are of a substantially rigid material, such as steel, aluminum, or a relatively hard plastic, sufficiently strong to prevent radial expansion of the flexible component 10 when high pressure fluid flows through the interior passage 12. Thus, the sleeves 24, 26 protect those portions of the flexible component 10 not radially bounded by the support wall 38 from expanding to “burst” the flush fit seal of the end portions 20, 22 when high pressure fluid flows through the interior passage 12. FIG. 7 shows the sleeve 26 around the flexible component 10 (in recess 16 of FIG. 1).

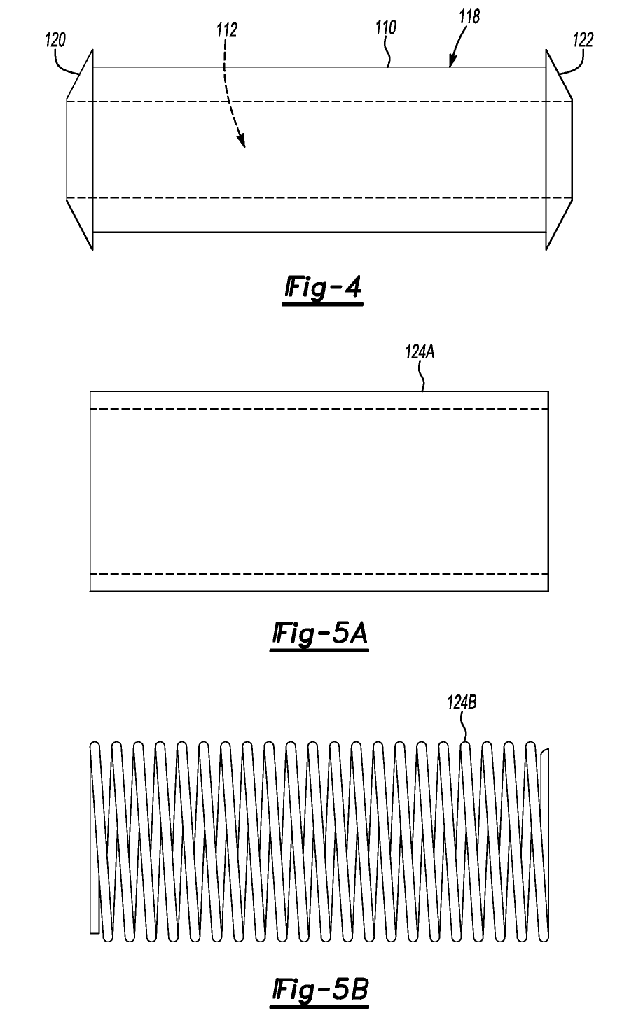

Referring to FIG. 4, a second embodiment of a flexible component 110 is shown with an interior passage 112 and an outer surface 118. The interior passage 112 runs completely thought the flexible component 110, including through tapered end portions 120, 122. Referring to FIG. 5A, a second embodiment of a substantially rigid annular sleeve 124 forms an opening 125 sized to fit snugly around the outer surface 118 of the flexible component 110 between the two end portions 120, 122 to form a pressurized fluid transport assembly. The outer surface of the sleeve 124 may be sized to fit through an aperture in a support wall, such as aperture 37 in FIG. 6, with the end portions 120, 122 sealing to the pressure source 32 and the pressure destination 134, in lieu of the assembly 28. The assembly formed by the flexible component 110 of FIG. 4 and the sleeve 124 of FIG. 5A may be able to accommodate even more tolerance stackup between the pressure source 32 and pressure destination 34 (i.e., even more variance in the distance D), as the midportion of the assembled component 110 and sleeve 124 need not be aligned axially with the support wall 38 as must midportion 40 of the assembly 28, because the midportion of component 110 is covered by sleeve 124, protecting it from radial expansion, unlike midportion 40 of component 10, which must be aligned with support wall 38 for protection from radial expansion. Referring to FIG. 5B, another embodiment of a sleeve 124B is shown which may be used in lieu of sleeve 124A. Sleeve 124B is a wound spring wire configured to fit around the outer surface 118 of the flexible component 110 of FIG. 4 between the two end portions 120, 122 to prevent radial expansion but allow axial compressibility of the flexible component.

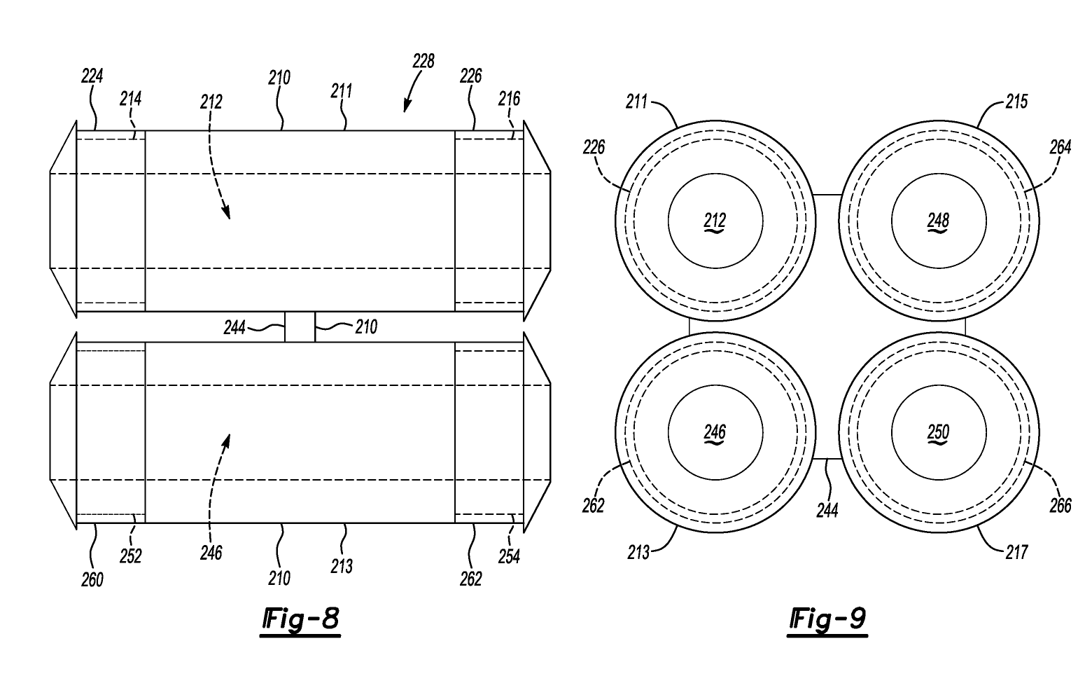

Referring to FIG. 8, a third embodiment of a pressurized fluid transport assembly 228 is shown. In this embodiment, the flexible component 210 has four conduit portions 211, 213, 215, 217 connected with one another via a flange portion 244. The conduit portions 211, 213, 215 and 217 and the flange portion 244 are a unitary flexible material that may be blow-molded and manufactured according to the process described in FIG. 14. There are no separate components to which the flexible component 210 is overmolded or otherwise integrated with. Each of the conduit portions 211, 213, 215 and 217 form a separate interior passage 212, 246, 248 and 250 for transporting pressurized fluid, which may be at different pressures.

Each conduit portion 211, 213, 215 and 217 is formed with two recessed portions, with only recessed portions 214, 216 of conduit portion 211 and recessed portions 252 and 254 of conduit portion 213 being visible in FIG. 8, but with like recessed portions formed in conduit portions 215 and 217. A respective annular sleeve is placed about each recessed portion, with annular sleeves 224, 226, 260 and 262 being visible in FIG. 8, and additional annular sleeves 264 and 266 being visible in FIG. 9.

The assembly 228 is designed for transporting fluid through four openings in a support wall from four separate openings in a pressure source such as pressure source 32 to four separate openings in a pressure destination such as pressure destination 34, with the end portions of each respective conduit portion 211, 213, 215, 217 flush fit against the openings due to the ability to compress axially. The midportion of each conduit portion of the flexible component 228 would be protected from radial expansion by the support wall, as is the midportion of the assembly 28 in FIG. 6.

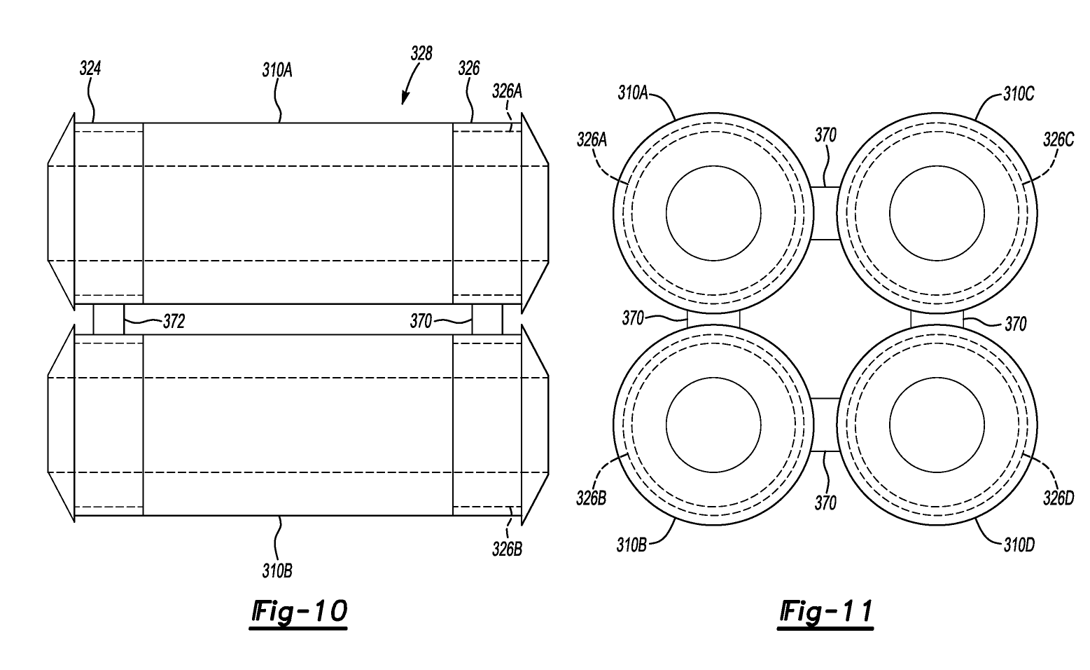

Referring to FIGS. 10 and 11, another embodiment of a pressurized fluid transport assembly 328 is shown. In this embodiment, four separate flexible components 310A, 310B, 310C and 310D are shown. Each of the flexible components 310A-310D is substantially identical to the flexible component 10 shown and described in FIG. 1. First and second sleeves 324 and 326 are fit within respective recessed portions of each of the flexible components, as shown in FIGS. 10 and 11. Each of the sleeves 324, 326 has four annular portions with a flange 370 connecting the annular portions such that the respective sleeve 324, 326 is a unitary component. The annular portions 326A, 326B, 326C and 326D of sleeve 326 are shown in phantom, hidden by the end portions of flexible components 310A, 310B, 310C and 310D, with the flange 370 connecting each of the annular portions 326A-326D.

Still other embodiments of fluid transport assemblies will be readily known to those skilled in the art based on the disclosure herein. For example, The flange portion 244 of FIGS. 8 and 9 may be formed at other locations along the conduit portions 310A-310D, or may be formed on conduit portions similar to the flexible component 110 of FIG. 4. Additionally, the integral sleeves each with four annular portions and a flange, shown in FIGS. 10 and 11, could be replaced by a single similar elongated sleeve in order to join four separate flexible components configured like flexible component 110 of FIG. 4. Also, the flange 370 of sleeve 326 (and like flange 372 of sleeve 324) may be of many different variations, each sufficient to connect the four annular portions 326A-326D (or annular portions (unnumbered) of sleeve 324) to form a unitary sleeve 326 (or 324).

Referring to FIG. 12, a die assembly 410 is shown. The die assembly 410 is used to mold the flexible component 110 of FIG. 4 according to the method of FIG. 13. The method of FIG. 13 may be applied to the other flexible components shown and described herein as well, by providing a differently shaped die cavity than die cavity 412 of FIG. 12. The die assembly includes die portions 413 and 415 that together form the cavity 412. Passages 414A and 414B lead from material reservoirs 416A and 416B, from which the material used to form the flexible component 110 is injected into the cavity 412. A core pin 418 is shown positioned above the cavity 412. According to the method 500 of FIG. 13, in step 502, the core pin 418 is extended into the die cavity 412 to the position shown in phantom as 418A (i.e., extending across the entire cavity 412). In step 504, the flexible component 110 is then molded around the core pin 418 in the die cavity 412 by injecting material from the reservoirs 416A, 416B. The molded component 110 may then be withdrawn from the die assembly 410 in step 506. Step 506 may include withdrawing the core pin 418 from the cavity 412 and opening the die assembly 410. With the flexible component 110 now completed, the sleeve 124A (or alternatively, sleeve 124B) may be placed around the outer surface 118 of flexible component 110 in step 108 to complete the pressurized fluid transfer assembly, which is then ready for use to transport fluid between the pressure source 32 and pressure destination 34 through the support wall 38 of FIG. 6.

While the best modes for carrying out the invention have been described in detail, those familiar with the art to which this invention relates will recognize various alternative designs and embodiments for practicing the invention within the scope of the appended claims.

1. An assembly for transporting pressurized fluid from a pressure source to a pressure destination through an aperture in a support wall, wherein the support wall, pressure source and pressure destination are substantially rigid, comprising:
an at least partially flexible component defining an interior passage for pressurized fluid flow therethrough and having an outer surface; wherein the flexible component is configured to fit through the aperture in the support wall and has a first end portion configured to fit flush with the pressure source and an opposing second end portion of the flexible component configured to fit flush with the pressure destination when the flexible component is fit through the aperture; and
a sleeve surrounding at least a portion of the outer surface of the flexible component between the pressure source and the pressure destination and configured to prevent expansion of the flexible component due to the pressurized fluid but to permit compression of the flexible component in a direction substantially parallel with the interior passage.

2. The assembly of claim 1, wherein the sleeve extends substantially from the first end portion to the second end portion through the aperture.

3. The assembly of claim 1, wherein the sleeve is a first sleeve extending only from the first end portion to the aperture and not through the aperture; and further comprising a second sleeve surrounding another portion of the outer surface of the flexible component and extending between the second end portion and the aperture and not through the aperture.

4. The assembly of claim 1, wherein the sleeve is a spring compressible in a direction substantially parallel with the interior passage.

5. The assembly of claim 1, wherein the flexible component is a rubber molded component.

6. The assembly of claim 1, wherein the interior passage is a first interior passage in a first conduit portion of the flexible component; and wherein the flexible component further defines a second conduit portion with a second interior passage in the second conduit portion.

7. The assembly of claim 6, wherein the flexible component further includes a flange connecting the first and second conduit portions.

8. The assembly of claim 6, wherein the sleeve further surrounds a portion of the outer surface of the second conduit portion.

9. A transmission comprising:
a pressure source;
a transmission case defining an aperture;
a pressure destination within the transmission case;
an at least partially flexible component defining an interior passage for pressurized fluid flow therethrough and having an outer surface; wherein the flexible component is configured to fit through the aperture in the transmission case and has a first end portion configured to fit flush with the pressure source and an opposing second end portion of the flexible component configured to fit flush with the pressure destination when the flexible component is fit through the aperture; and
a sleeve surrounding at least a portion of the outer surface of the flexible component between the pressure source and the pressure destination and configured to prevent expansion of the flexible component due to the pressurized fluid but to allow compression of the flexible component in a direction along the interior passage between the two end portions.

10. The assembly of claim 9, wherein the sleeve extends substantially from the first end portion to the second end portion through the aperture.

11. The assembly of claim 9, wherein the sleeve is a first sleeve extending only from the first end portion to the aperture and not through the aperture; and further comprising a second sleeve surrounding another portion of the outer surface of the flexible component and extending between the second end portion and the aperture and not through the aperture.

12. The assembly of claim 9, wherein the sleeve is a spring compressible in a direction substantially parallel with the interior passage.

13. The assembly of claim 9, wherein the flexible component is a rubber molded component.

14. The assembly of claim 9, wherein the interior passage is a first interior passage in a first conduit portion of the flexible component; and wherein the flexible component further defines a second conduit portion with a second interior passage in the second conduit portion.

15. The assembly of claim 14, wherein the flexible component further includes a flange connecting the first and second conduit portions.

16. The assembly of claim 14, wherein the sleeve further surrounds a portion of the outer surface of the second conduit portion.

17. A method of manufacturing a pressurized fluid transfer assembly, comprising:
extending a core pin into a die cavity formed by a die assembly;
molding a flexible component in the die cavity around the core pin without inserting an additional component in the die cavity so that the molded flexible component is of a single molded material and forms an internal passage around the core pin;
withdrawing the molded component from the die assembly and the core pin; and
placing a sleeve around at least a portion of the flexible component to at least partially surround the internal passage.
